(19) United States
(12) Patent Application Publication
(10) Pub. No.: US 2022/0117808 A1
(43) Pub. Date: Apr. 21, 2022

(54) TRANSFER ASSIST PULL HANDLES AND METHODS OF USE THEREOF

(71) Applicant: Stand Yourself Up, LLC, Anderson, SC (US)

(72) Inventor: Albert Gallatin Grantham, IV, Anderson, SC (US)

(73) Assignee: Stand Yourself Up, LLC, Anderson, SC (US)

(21) Appl. No.: 17/425,005

(22) PCT Filed: Jan. 24, 2020
(86) PCT No.: PCT/US2020/014879

§ 371 Date: Jul. 22, 2021

Related U.S. Application Data
(60) Provisional application No. 62/796,915, filed on Jan. 25, 2019.

(51) Int. Cl. A61G 5/14

(52) U.S. Cl. CPC A61G 5/14; A61G 7/053

(57) ABSTRACT

Specifically positioned handlebars integrated into a structure, such as armrests, wheelchairs, commodes, beds or other assistive device structures, wherein the handles extend from the structure and allow the user to pull themselves into a standing position with less assistance from a third party.

### BACKGROUND OF THE INVENTION

### 1) Field of the Invention

The present invention relates to specifically positioned handlebars integrated into a structure, such as armrests, wheelchairs, commodes, beds or other assistive device structures, wherein the handles extend from the structure and allow the user to pull themselves into a standing position with less assistance from a third party.

### 2) Description of Related Art

An aging population means there is a growing number of people with declining health and increased need for care. There are also people with debilitating or degenerative diseases. Together, there is an increasing number of people requiring wheelchairs for mobility, help to use commodes, assistance to get out of bed and support to use other necessary devices to strengthen their bodies and improve their fitness. Because of this, there is a growing need to assist patients to stand up and improve their mobility.

Given the aging population and increased mobility needs, improved mobility devices are needed. Accordingly, it is an object of the current disclosure to provide an improved handle design specifically positioned so that the user can easily pull themselves up into standing from a seated or resting position. This increases mobility, the independence of the user, and minimizes the need for a support care person or professional.

### SUMMARY OF THE INVENTION

The above objectives are accomplished according to the present invention by providing in a first embodiment a transfer assist pull handle. The transfer assist pull handle may include at least one mounting bar, at least one extension tube, movably engaged with the mounting bar to move at least longitudinally and at least rotationally with respect to the mounting bar, at least one grasping handle integrally formed on or connected to the extension tube, at least one clamp attached to the at least one mounting bar for affixing the transfer pull assist handle to another object, and at least one locking mechanism that locks the at least one extension tube into position with respect to the at least grasping handle. Further the transfer assist pull handle may include at least one hinge in the at least grasping handle. Still further the pull handle may include a furniture adapter sleeve and a mounting bar shell. Still yet, a cushion may be affixed to the transfer assist pull handle. Yet again, an adjustable securing mechanism and affixer may be connected to the transfer assist pull handle. Still again, a locking ring may connect the at least one mounting bar and the at least one extension tube. Yet further, an assistive frame may be affixed to the transfer assist pull handle. Still yet, a second transfer assist pull handle may be connected to the at least one transfer assist pull handle via an adjustable securing bar. Again further, the transfer assist pull handle and the second transfer assist pull handle may be affixed to the adjustable securing bar via rotating clamps that provide for rotating the transfer assist pull handle and the second transfer assist pull handle independently of one another with respect to the adjustable securing bar. Still yet again, the transfer assist pull handle may be attached to a wheelchair, commode, other mobility accessory or fixed structure. Again yet, a joining platform may connect the at least one transfer assist pull handle to a second transfer assist pull handle. Further still, the transfer assist pull handle may be attached to a vehicle interior.

In another embodiment, a method for improving accessibility for an existing fixture via installation of a transfer assist pull handle is provided. The method may include joining at least one mounting bar to a first surface of the existing fixture via at least one clamp attached to the at least one mounting bar and the first surface of the existing fixture, joining at least one extension tube to the at least one mounting bar; the extension tube is movably engaged with the mounting bar to move longitudinally and rotationally with respect to the mounting bar, forming at least one grasping handle on the extension tube, and forming at least one locking mechanism that locks the at least one extension tube into a position with respect to the at least one grasping handle. Still further, a second mounting bar may be joined to a second surface of the existing fixture. Yet still, there may be at least one hinge in the at least one extension tube. Still yet, a furniture adapter sleeve and a mounting bar shell may be added to the mounting bar. Again, a joining platform may connect a first transfer assist pull handle to a second transfer assist pull handle. Again still, the transfer assist handle may be connected to an adjustable securing mechanism and affixer. Further again, the at least one mounting bar and the at least one extension tube may be connected via a locking ring. Still yet, the transfer pull handle may be connected to an assistive frame. Again yet, a first transfer pull handle may be connected with a second transfer assist pull handle via an adjustable securing bar affixed to the existing structuring wherein the first transfer pull handle and the second transfer pull handle are both affixed to the adjustable securing bar. Still further, the first transfer assist pull handle and the second transfer assist pull handle may be affixed to the adjustable securing bar via rotating clamps that provide for rotating the transfer assist pull handle and the second transfer assist pull handle independently of one another with respect to the adjustable securing bar. Still yet, the transfer assist pull handle may be attached to a wheelchair, portable commode, or other mobility accessory. Further yet still, at least one transfer assist pull handle to a vehicle interior.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1A shows a handle of the current disclosure affixed to a wheelchair.

FIG. 1B shows a side view of one embodiment of a handle of the current disclosure.

FIG. 1C shows a bottom view of one embodiment of a handle of the current disclosure.

FIG. 1D shows a close-up view of a mounting bar of the current disclosure.

FIG. 1E shows an end on view of the mounting bar with the extension tube shown engaged via a rotational limiting button.

FIG. 1F shows a disassembled handle of the current disclosure.

FIG. 1G shows embodiments of handles of the current disclosure with disparate hinge placement in the handle bodies.

FIG. 1H shows a disassembled via of a handle of the current disclosure.

FIG. 1I shows one embodiment of mounting bar 104.

FIG. 1J shows an end view of a mounting bar of the current disclosure.

FIG. 2 shows a photograph of one embodiment of the current disclosure.

FIG. 3 shows an adjustable securing mechanism of the current disclosure.

FIG. 4 shows a close up view of a joint that may be used with handles of the current disclosure.

FIGS. 5A and 5B show handles of the current disclosure affixed to a bed.

FIGS. 6A, 6B, and 6C show an embodiment of the current disclosure used to affix a handle to a chair.

FIGS. 7A and 7B show a further embodiment of the current disclosure with two handles connected via a joining platform.

FIG. 8A shows an extension tube of the current disclosure disconnected.

FIG. 8B shows grasping tube proximal end disconnected from extension tube distal end.

FIG. 8C shows a grasping handle proximal end engaging with an extension tube distal end.

FIG. 8D shows a grasping handle proximal end joined to an extension tube distal end.

FIG. 8E shows a grasping handle affixed to an extension tube.

FIG. 8F shows possible angles that may be applied to a grasping handle of the current disclosure.

FIG. 9A shows handles of the current disclosure associated with a commode or waste facility.

FIG. 9B shows the structure of FIG. 9A disassembled.

FIG. 10 shows a method for improving accessibility to and from an existing fixture to assist users in raising themselves from a prone, supine, or sitting position to a standing position without the need for third party.

FIG. 11 shows one embodiment of a handle that may be used for egress and ingress with respect to a motor vehicle.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

As people age, they can become disabled in many ways, lose flexibility, strength, motor/cognitive function, have increased fear of falling, and have a great deal more pain. Their bodies have had wear and tear over the years and they often need assistance getting out of their chair, bed, or off the commode. The transfer assist handles of the current disclosure allow a patient to pull themselves up by a more stable and larger group of muscles into a better or new position. Once in a better ergonomic position, it is easier and less painful for a larger muscle group (legs) to take over and help them achieve a new position. Due to the frequency of falls in the disabled population, the handles also offer security to the user to have a stable grip before their next transition.

The handles of the current disclosure superior and anterior position allow for forward repositioning while maintaining a more neutral cervical and thoracic vertebrae. The gentle pulling motion may also allow a patient to better adhere to a physician's spinal surgical & fracture precautions of no twisting, bending, or lifting and help them maintain a neutral lumbar sacral spine. After installation by a trained individual, the patient will extend the bars to an appropriate length and rotate them to the “up” position. Once at the desired length and the seat is stable, such as the brakes on a wheelchair being engaged, the person may reach forward to the handle grips and pull themselves up by pulling in a downward motion while simultaneously attempting to stand with their legs. Once in standing the user may steady themselves upright before ambulation.

One aspect of the present invention is specifically positioned handlebars integrated into a fixture or structure such as an armrest, construction of a wheelchair, commode, bed or other assistive device structure. In one embodiment, the bar may be comprised of: an outer bar defining an internal slot; an inner bar slidably engaged within the internal slot of the outer bar; and a lock configured to releasably lock the outer bar to the inner bar and at least one locking mechanism that locks the at least one grasping handle bar into position with respect to the at least one extension tube and at least one locking mechanism that allows rotation into position and storage of the angled grasping handle bar. The handlebar may also fold out via the use of hinges as well as lock into place in a variety of poses and positions as well as at a variety of angles.

In a further embodiment, the handlebar adapter comprises: an adapter plate with an upper surface, a lower surface and may include a sidewall; an outer bar with a defined internal slot integrated to the adapter plate; an inner bar slidably engaged within the outer bar; a lock configured to releasably lock the outer bar to the inner bar, which in turn connects to an angled grasping handle, handlebars will be present to maximize user pulling potential, wherein the adapter plate may be integrated to a structure such as an armrest of a seat or other construction.

In another embodiment, the handlebar with an outer bar, an inner bar, and a grasping handle, which slidably engage and lock, will be integrated directly into the fixture or structure such as armrest, seat, cushion, etc., of the original medical transfer device such as wheelchair, commode, walker, lift chair and the like, with the handle grip present where needed to maximize user pulling potential.

In another embodiment, the handlebar with an outer bar and inner bar slidably engaging and locking along with a grasping handle affixed to the inner bar, will be integrated to the outside of the existing structure such as wheelchair, bedside commode, lift chair, walker, etc. The handle grip is present where needed to maximize user pulling potential. In another embodiment, the device may be engaged with and locking will be integrated with the brakes of a wheelchair, where a user may pull themselves to stand.

The current disclosure's handlebar, grip, and handle may be any shape and may adjust length, height and rotate to adjust to all angles obtuse, acute, and right and all angles in the x, y, z planes with respect to the mounting bar attached to a fixture or structure. The current disclosure also includes methods of affixing handles of the current disclosure to retrofit an existing device or structure, as well as includes the design and the manufacture of existing or new structures or devices.

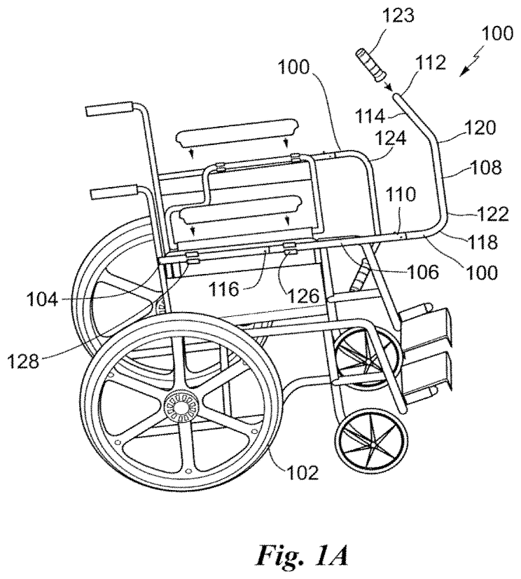

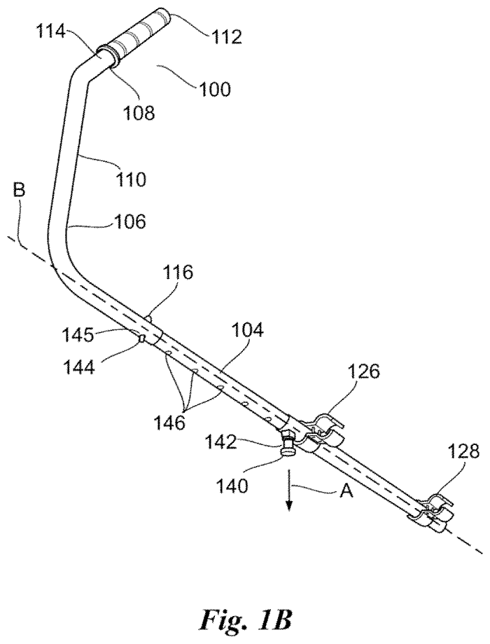

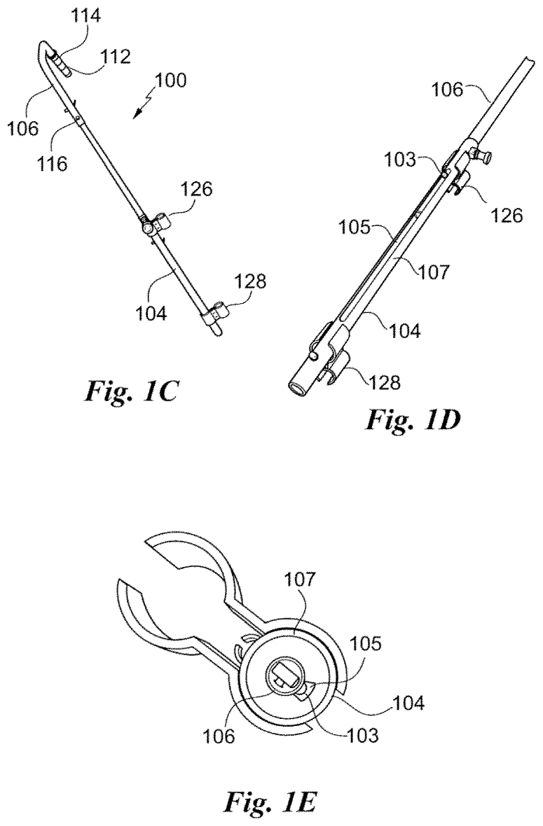

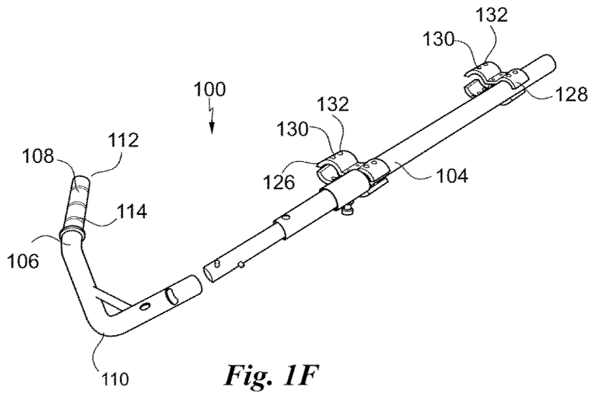

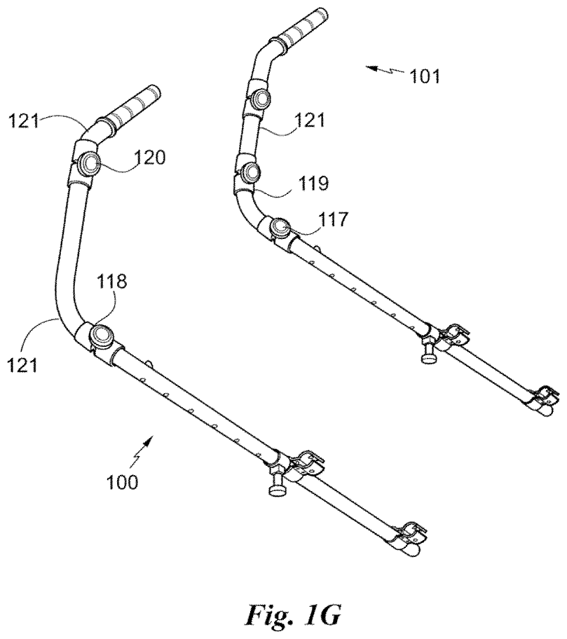

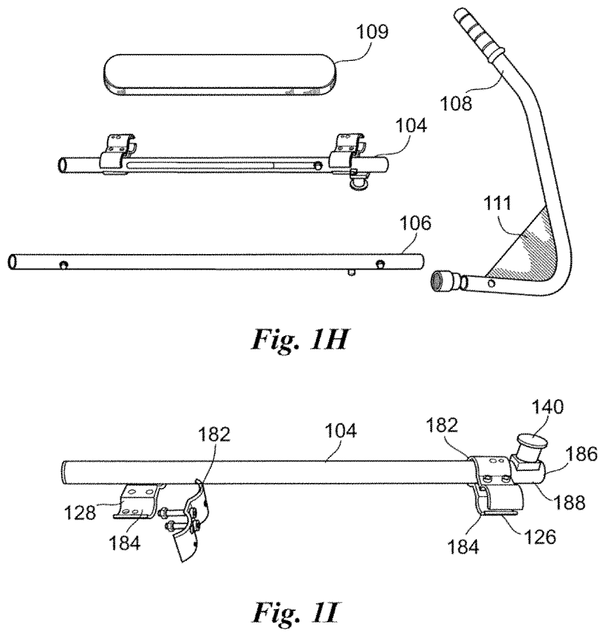

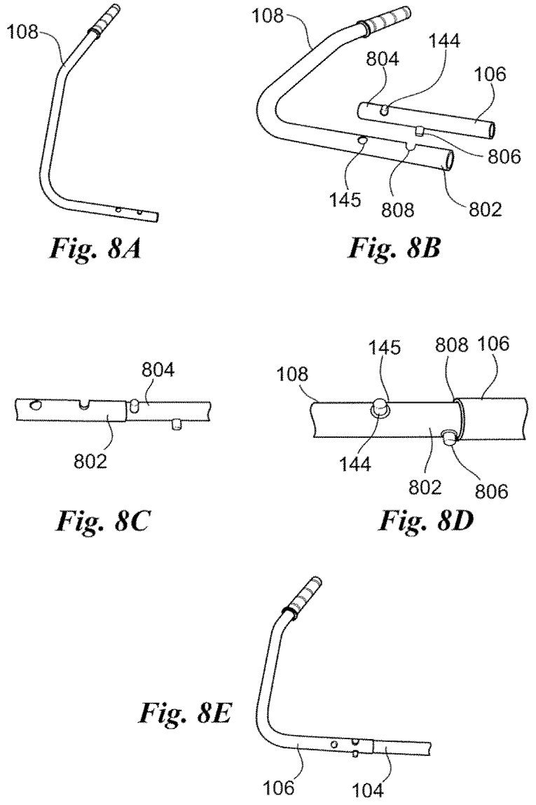

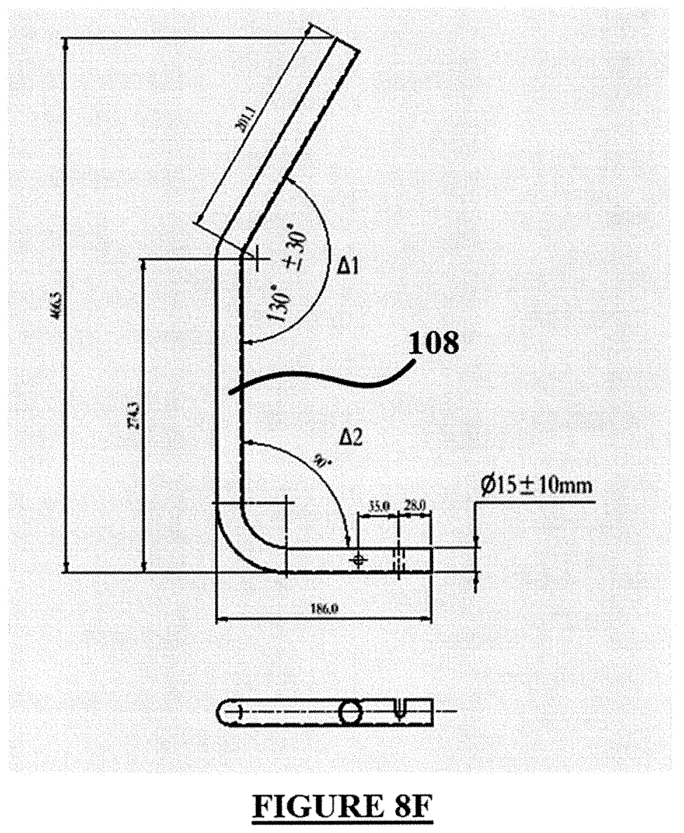

FIG. 1A shows one embodiment of pull handles 100 affixed to a wheelchair 102. Handles 100 may be comprised of plastic, metal, synthetics, etc., as known to those of skill in the art. In one embodiment, handles 100 may be formed from metals such as steel and aluminum, plastics, such as PE, PP, PVC and ABS, and composites, reinforced with glass fiber, carbon fiber, nylon, aramid fibers and the like. Handles 100 may include a mounting bar 104. Mounting bar 104 may be affixed to a wheelchair, commode, armrest, wall, bed frame, vehicle interior, or other structure. Handles 100 may also include extension tube 106, extension tube 106 may be separable or formed integrally with handles 100. Extension tube 106 may be affixed to grasping handle 108 for a person to move themselves into a changed position. Grasping handle 108 may run substantially perpendicular to extension tube body 110 and distal end 112 of grasping handle 108 may form a tilted grasping element 114 to provide additional leverage for a user. Further, an additional grip surface 123, such as a hand grip formed from rubber, plastic, synthetic, or other material, may be placed onto distal end 112 of grasping handle 108. Conveniently, handles 100 are constructed so that the entirety of grasping handle 108, not just tilted grasping element 114, may be used to grasp and pull by the user in order to provide a variety of different leverage points along grasping handle 108. With respect to FIG. 8F, the angle (Δ1) of the angled grasping handle bar is typically 130 degrees+/−30 degrees, combined with the roughly 90 degree (substantially perpendicular) distal end of the extension tube. This geometry creates an important downward force into the base of the seated structure forcing the seated structure to stay firmly on the floor and prevent forward or backward or lateral tipping. Grasping handle 108 and extension tube 106 may extend, retract, telescope, fold, such as via the use of hinges or collapsible joints, and/or be secured in all angles and planes for optimal utility with respect to mounting bar 104. This may be accomplished via locking grasping handle 108 and/or extension tube 106 into place with mounting bar 104, via locking mechanism 116. Rotation may be accomplished via turning grasping handle 108 around extension tube 106 with respect to mounting bar 104 as well as by using first hinge 118 and second hinge 120 within grasping handle body 110. While two hinges 118 and 120 are shown, more or less hinges are considered within the scope of this disclosure such as one, three, four, five, or more hinges. Indeed, first pull handle 122 and second pull handle 124 may have mirroring or different hinge placements, such as different hinge placement with respect to first pull handle 122 and second pull handle 124 in order to accommodate right or left hand dominant users who may have different body physics and/or injured users wherein they cannot exert the same pressure from each arm. In use, handles 100 may be affixed to a wide variety of fixtures such as medical devices, such as but not limited to wheelchairs, commodes, walkers, assistance frames, beds, walls, ceilings, chests, trunks, chairs, sofas, vehicle interiors, etc. Given the versatile configuration of handles 100 and the wide ranges of motion vis-à-vis mounting bar 104 and extension tube 106, the device of the current disclosure has many significant uses for assisting individuals with raising or pulling themselves from a prone, supine, or sitting position.

FIG. 1B shows a side profile of handle 100. FIG. 1C shows a bottom view of handle 100. FIG. 1D is a close-up view of mounting bar 104 showing extension tube 106 using rotational limiting button 103 engaged with groove 105 to prevent rotation of extension tube 106 with respect to mounting bar 104. While a single groove 105 is pictured, multiple grooves 105 may be defined within mounting bar body 107 to allow for varied positioning and angling of mounting bar 104 with respect to extension tube 106. Indeed, while groove 105 is shown as straight, the groove may be curved or angled to allow for shifting the angle of extension tube 106 with respect to mounting bar 104. FIG. 1E shows an end on view of the mounting bar 104 with extension tube 106 shown engaged via rotational limiting button 103.

FIG. 1B also shows pull button lock 140. Pull button lock 140 may be spring loaded and welded or otherwise affixed to mounting bar 104. When one pulls circular handle 142, a spring, not shown, coils and allows pin 144 to come out of extension tube engagement orifice 145 defined in extension tube 106. When you release circular handle 142 the spring relaxes and pin 144 may drop into one of the holes in extension tube 106. By pulling outward, shown by arrow A, away from mounting bar 104, on circular handle 142, this can release locking mechanism 116 by releasing pin 144 from extension tube engagement orifice 145 defined in extension tube 106 and hole 146 defined in mounting bar 104, while FIG. 1B shows six holes, more or less holes are considered within the scope of this disclosure such as 1, 2, 3, 4, 5, 7 or more, and releases pin 144 from frictional engagement with holes 146 defined in mounting bar 104.

Further, while a single extension tube engagement orifice 145 is shown, more are considered within the scope of this disclosure and herein disclosed such as 2, 3, 4, 5, etc. Extension tube engagement orifices 145 may be positioned circumferentially around extension tube body 110 to allow for positioning extension tube 106 at various angles with respect to axis B running throughout the length of mounting bar 104. For example, viewing the end of mounting bar 104 face one, grasping handle 108, with respect to extension tube 106 and mounting tube 104, could be angled at 0, 45, 90, 135, and 180 degrees with respect to axis B running through mounting bar 104. Other angles are also considered within the scope of this disclosure such as 15, 60, 105, 150 degrees, etc. One may also reposition extension tube 106 along the length of mounting bar 104 by releasing circular handle 142, which may reengage locking mechanism 116 by having pin 144 engage with another hole 146 located at a different position along mounting bar 104 to lengthen or shorten handle 100 via insertion of more or less of the length of mounting bar 104 into the cavity defined by hollow extension tube 106.

FIG. 1F shows handle 100 disassembled. With respect to fixed claim 126 and variable clamp 128, these may both define at least first clamp hole 130 and second clamp hole 132. Preferably holes 130 and 132 are different sizes with respect to one another. The different hole diameters accommodate the variety of fasteners used on different medical transfer devices. For example, either the smaller hole or the bigger one can be used to attach the handle to any type of wheelchair armrest. Furthermore, the screws that fix the armrests to the wheelchair are smaller in diameter than the screws that fix the armrests to devices such as commode devices. In this invention, moveable clamps will be formed to fit and be interchangeable between wheelchair armrests, commode armrests, and any other medical transfer device as desired. This means that one universal attachment method is possible, which allows for the application of only one handlebar model, lowering manufacturing and inventory costs. Fixed clamp 126 may be made removable or integral with mounting bar 104. Variable clamp 128 may be removable from mounting bar 104.

FIG. 1G shows an embodiment where handles 100 may have varied hinge placement such as in one example first hinge 118 and second hinge 120 configured in elbows 121 of extension tube body 110. Second handle 101 may have third hinge 117, fourth hinge 119 and fifth hinge 121 in different positions vis-a-vis handle 100 in order to allow the user to exert different pressures, torques, strains, with the different hinge configurations.

FIG. 1H shows mounting bar 104, extension tube 106, grasping handle 108, and armrest 109 disassembled. Armrest 109 may be affixed to mounting bar 104 via bolts, screws, adhesives, welds, clamps, frictional engagement, etc. as known to those of skill in the art. Grasping handle 108 may also include reinforcement plate 111. Reinforcement plate 11 may serve to strengthen grasping handle 108 and to prevent grasping handle 108 from undesirably bending or flexing while in use. Further, while locking mechanisms are described herein, mounting tube 104, extension tube 106, and grasping handle 108 may also be designed with geometries that allow for the three to telescope with respect to one another for extension/retraction purposes.

Another aspect of the current disclosure is the various uses of mounting bar 104 with respect to healthcare equipment. FIG. 1I shows a close up view of mounting bar 104 with variable clamp 128 disassembled. While mounting bar 104, extension tube 106, and grasping handle 108 are shown with substantially round bodies, the current disclosure should not be considered so limited. Indeed, the cross sections/tubing of the bodies of the three may be any shape such as square, rectangular, polygon, ellipsoid, semi-circular, etc.

In use, mounting bar 104 may be affixed to a structure such as a wheelchair, armrest, recliner, walker, vehicle interior, etc., via a fixed clamp 126. Fixed clamp 126 may be a c-shaped or other compatibly shaped piece(s) integrated with mounting bar 104 and can be coupled to an armrest, bar, car interior, bar frame, walker, wheelchair frame, etc. As FIG. 1I shows, variable clamp 128 and fixed clamp 126 may be formed to grasp onto mounting bar 104 via first clamp ends 182 with second clamp ends 184 designed to clamp onto a walker, wheelchair, commode support, etc. Again, while shown to accommodate round tubing, fixed clamp 126 and variable clamp 128 are not limited to one shape and may indeed have different ends with respect to one another in view of shape. Indeed, the clamps may be designed to fit onto the structures of medical devices whether the shape be square, rectangular, polygon, ellipsoid, semi-circular, etc. Fixed clamp 126 is able to loosen or tighten in order to accommodate smaller or larger armrest diameters, such as different sized tubing on a wheelchair, the diameter of different sized chairs, etc. Fixed clamp 126 may be used in association with variable clamp 128 to secure handle 100 to an armrest of a wheelchair, walker, etc. Variable clamp 128 may be at least one c shaped piece(s) free to move about and adjust to various lengths of armrests by engaging with the bar and can be coupled to the armrest, the variable clamp is able to loosen or tighten in order to accommodate smaller or larger armrest tubing. Variable clamp 128 may be used with fixed clamp 126 as a method of secure attachment to an armrest for accessories. Further, while fixed clamp 126 is describe as “fixed” both clamps may be variable in position and slide or other engage at various positions along mounting bar 104 or both clamps may be fixed clamps that do not move. Further, the clamps may be designed with multiple, different sized holes so that the clamps can secure to the screw/assembly member pattern of a wheelchair, commode, bed, or other seated structure. The variable clamp may move about mounting bar 104 and secure to the desired hole of the screw pattern. The combination of the before mentioned multiple screw hole sizes for the various fasteners and the bracket clamping action, will allow for a secure hold against pressure from all planes and angles.

Referring to 1J, another important aspect of mounting bar 104 is universal adapter end 186 located at distal end of mounting bar 188. While the current disclosure explains that extension tube 106 may be inserted into universal adapter 186 via insertion of extension tube 106 into the interior 190 of mounting bar 104 and locking or otherwise engaging in place with respect to mounting bar 104, many other variations are possible. Indeed, grasping handle 108 may be inserted directly into universal adapter 186, as well as any other fixture, such as a table, lap tray, light, computer station, etc. Essentially any device may be mounted onto mounting bar 104 if the device has a support that fits within or grasps onto universal adapter end 186 or mounting bar 104. This allows for a host of accessories to be affixed to any structure via use of mounting bar 104.

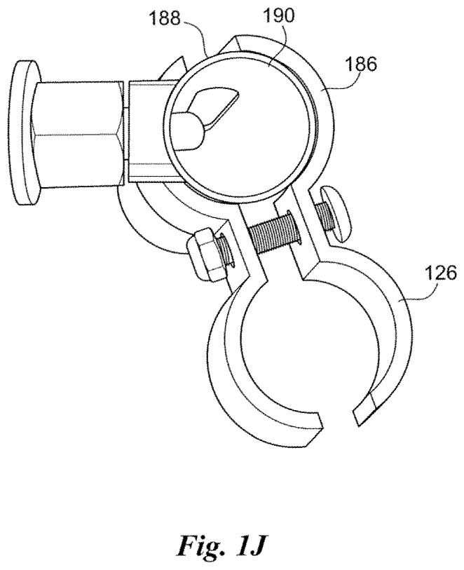

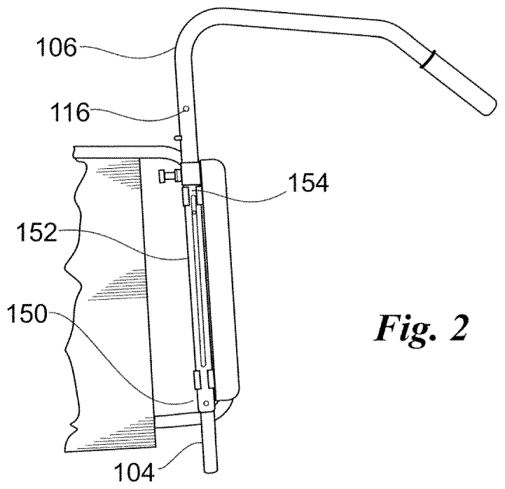

Referring to FIG. 2, locking mechanism 116 may be a spring loaded pull or push button to secure extension tube 106 to mounting bar 104 via extension tube 106 sliding over mounting bar shell 152. Furniture adapter sleeve 150 may be designed as at least one shaped piece that will adjust and create a form fitting arch to a furniture armrest. Furniture adapter sleeve 150 may loosen or tighten to accommodate smaller or larger armrests. Cushion 154 may also be included and may comprise a soft material on top of furniture adapter sleeve 150.

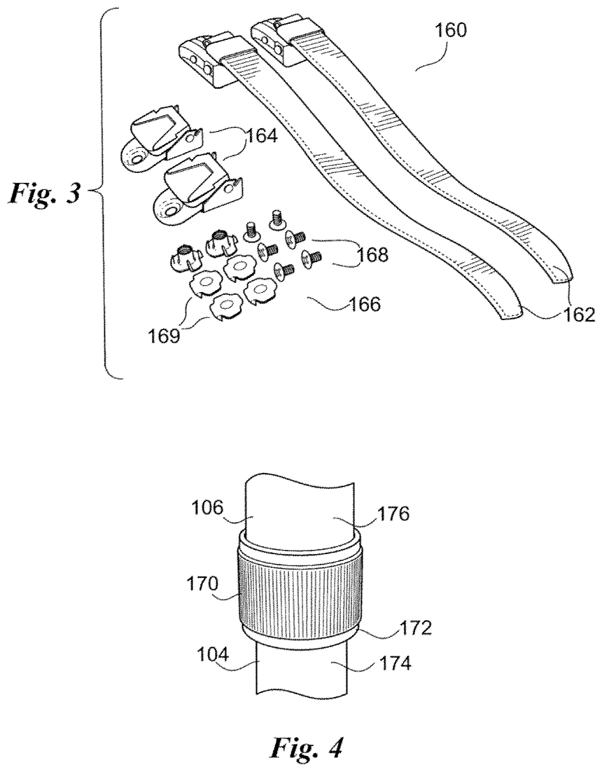

Referring to FIG. 3, adjustable securing mechanism 160 may be used with handles 100. Adjustable securing mechanism 160 may include at least one affixer 162, which may be a strap, strip, bar, or other structure as known in the art, that will secure furniture adapter sleeve 150 to a structure such as the arm of a sofa, recliner, chair, walker, rail for a commode, etc. Affixer clamps 164 may serve to “cinch” affixers 162 tightly to the surface to which they are secured, such as the support frame for a chair or sofa. Attachment hardware 166, such as screws 168 and washers 169, may be used to secure clamps 164 to the furniture or structure to which adjustable securing mechanism 160 is being affixed. This allows for a wide range of freedom for installing the device of the current disclosure to non-uniform shaped structures such as stuffed arm couches, crenelated chair arms, etc.

Referring to FIG. 4, this figure shows a close up view of joint 172 wherein locking ring 170, such as a screw ring or other type of joint as known to those of skill in the art, may be used to join together, secure, and decrease “wiggle play” between mounting bar 104 and extension tube 106. In one embodiment, locking ring 170 secures mounting bar distal end 174 and extension tube proximal end 176 together.

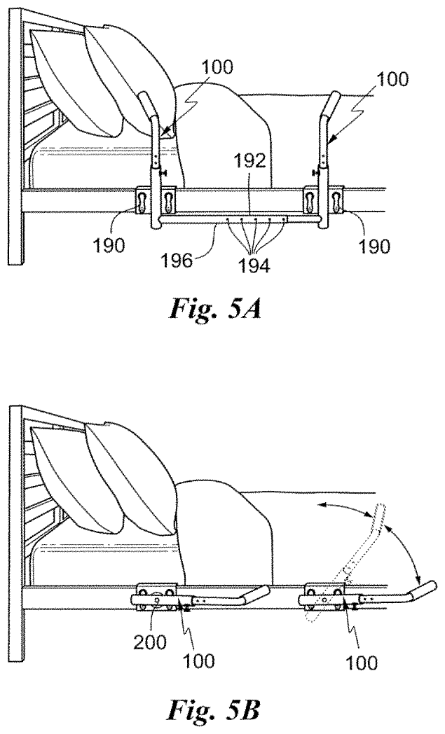

FIGS. 5A and 5B show an alternative affixment scheme for the device of the current disclosure. Here, handles 100 may employ structure attachment clamps 190 and an adjustable securing bar 192, which may comprise a rounded or flat bar with openings 194 to allow for varying the position of handles 100 across length 196 of adjustable securing bar 192 via pins, clips, etc., as known to those of skill in the art. This arrangement allows a user to attach handles 100 to basically any surface to provide support, such as a bed frame, wall, ceiling, book case, chest of drawers, etc.

FIG. 5B shows that handles 100 may be affixed to a structure via a rotating clamp 200 that allows handles 100 to rotate from a flat position to an upright position. The rotating clamps are integrated to the mounting bar. The clamps will lock by a fin on the outer surface of the mounting bar or extension tube, fitting into a groove on the clamp when pulled towards the user and rotated in the “up” and “ready to use” position. The storage position of the transfer assist handle is vertical and parallel to the frame. Disengaging the lock, will allow the operator to turn the transfer assist handle to rotate 90 degrees to an upright and perpendicular position. The handle then snaps into a secure locked position. To bring the transfer assist handle back to the storage position the operator is required to disengage the lock mechanism and turn it back 90 degrees. Rotating clamp 200 may serve to lock handles 100 into at any degree of motion within 360 degrees in a plane A parallel to the structure to which handles 100 are attached. Clamps 200 may also allow handles 100 to rotate into and out of plane A by as much as 360 degrees in order to allow handles 100 to be positioned “closer” or “farther” to the affixment structure as well as allow for handles 100 to move at acute, right or obtuse angles with respect to the affixment structure. Thus, clamps 200 may allow for movement in the X, Y and Z planes with respect to plane A and/or the affixment structure to allow for precise placement of handles 100. Further, rotating clamp 200 allows for independent positioning of two or more handles 100 with respect to one another and the securing bar 192 to allow for maximum positioning possibilities.

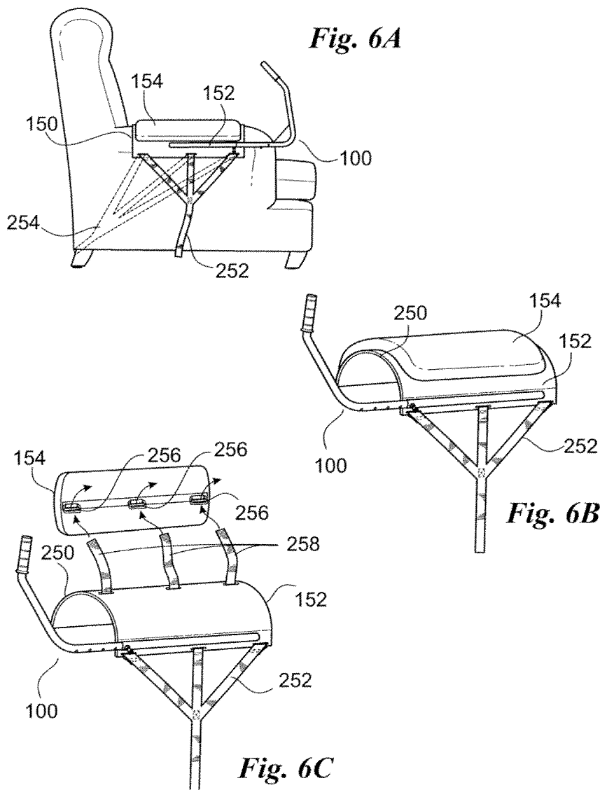

FIGS. 6A-6C show one embodiment of the current disclosure wherein handles 100 are used in combination with furniture adapter sleeve 150 to secure handles 100 to an object such as a piece of furniture, such as a recliner. Furniture adapter sleeve 150 may be formed to define an adapter arch 250 shaped to create a form fitting arch to a furniture armrest, furniture adapter sleeve 150 may loosen or tighten to accommodate smaller or larger armrests via the use of tightening strap 252 which may encircle the back of the piece of furniture to secure a first handle 100 to a second handle 100 by circling behind the back support of the chair/recliner/loveseat, etc., to affix to the opposing handle. Further support may be added via introduction of placement straps 254 that would run under the piece of furniture from a first handle 100, under the seat or bottom of the furniture to a second handle 100 on the opposing armrest. Cushion 154 may also be included and may comprise a soft material on top of furniture adapter sleeve 150. FIG. 6C shows that cushion 154 may be held into place via cushion buckles 256 and ratchet straps 258 which cinch cushion 154 tightly to adapter arch 250 via pulling ratchet straps 258 through buckles 256 and pulling same tight.

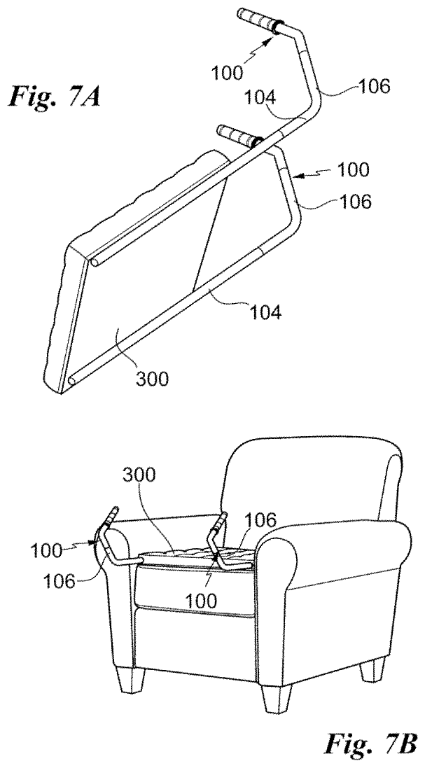

FIGS. 7A and 7B show an alternative embodiment of the current disclosure wherein handles 100 are joined via joining platform 300, which may comprise a cushion, mesh platform, wooden seat, etc. The cushion may comprise of readily available materials including polymeric cushioning foams and stuffing materials, upholstery fabrics and synthetic or natural covering materials, may be filled with water, mesh, gel, may be heated, cooled, air filled and may have an inflation valve to release air for pressure relief and it may be pumped back up with air. The cushion may be made of a type of rubber with air cells for maximum pressure relief for the user to prevent pressure ulcers from forming.

FIG. 8A shows extension tube 106 disconnected. FIG. 8B shows grasping handle proximal end 802 disconnected from mounting bar distal end 804. Engagement of extension tube proximal end 802 and extension tube distal end 804 may be accomplished by engagement orifice 145 allowing pin 144, which may be a spring loaded pin as known in the art, to extend upward and out of engagement orifice 145, thus securing grasping handle 108 in position with extension tube 106. Extension tube 104 may also include groove engagement pin 806, which may also be a spring loaded pin as known in the art, for engaging groove 808 defined within grasping handle 108 adjacent grasping handle proximal end 802. Groove 808 allows grasping handle 108 to swivel around extension tube distal end 804 in order to reposition grasping handle 108 via engagement of pin 144 with other engagement orifices 145 located circumferentially around grasping handle 108 to allow for varied positioning of grasping handle 108. FIG. 8C shows grasping handle proximal end 802 engaging with extension tube distal end 804. FIG. 8D shows grasping handle proximal end 802 joined to extension tube distal end 804. Groove engagement pin 806 is seated within groove 808 and pin 144 is protruding through engagement orifice 145 to secure grasping handle 108 to extension tube 106. FIG. 8E shows a grasping handle 108 affixed to extension tube 106.

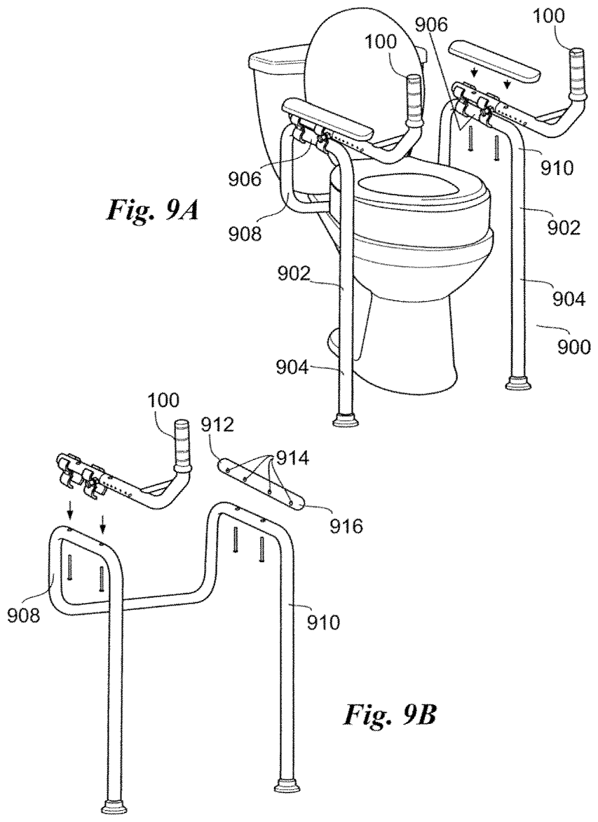

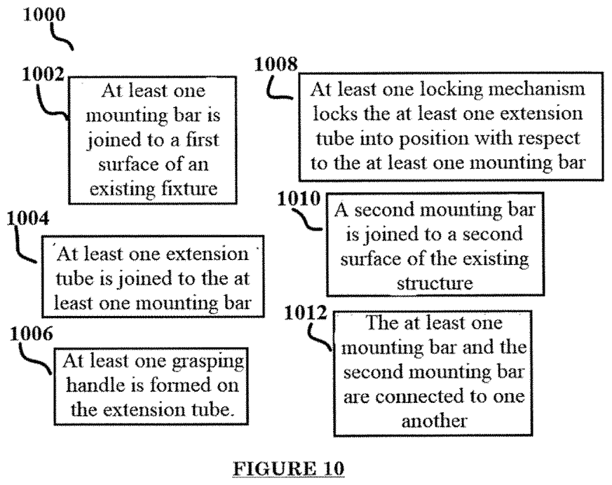

FIG. 9A shows handles 100 of the current disclosure used with assistive frame 900 in order to allow handles 100 to be integrated with a commode or other waste facility. As FIG. 9A shows, assistive frame 900 may include stanchions 902 forming leg supports 904 and armrests 906 for engaging the upper surface of a toilet or other waste facility. Assistive frame 900 may be a single piece with first side 908 and second side 910 integrally associated with one another or, in a further embodiment, first side 908 and second side 910 may be joined via a assistive frame connector 912, see FIG. 9B. Assistive frame connector 912 may include connector holes 914 that may be defined throughout connector body 916 at various lengths to allow for adjusting assistive frame 900 to fit various widths of commodes or other waste facilities via screws, bolts, or other fixtures inserted through distal ends of first side 908 and second side 910 to join the sides to connector 912 as known to those of skill in the art. FIG. 9B shows assistive frame 900 and handle 100 disassembled.

Handles 100 may be sold as a set of two bars, a left-hand bar and right-hand bar, for use with patients with Alzheimer's/dementia, CVA, MS, Cerebral Palsy, Parkinson's, lower extremity amputation, compression fracture, and age related weakness. Handle 100 may also be employed singly for patients with one-sided weakness such as hemiplegia and hemiparesis, patients with cervical or lumber nerve damage that weakens one arm or legs, bone-fractures, shoulder surgeries, and some patients fitted with a pacemaker or defibrillator who are all under doctor orders for non-weight bearing through those extremities. One key factor for the current disclosure is that handles 100 may be built into, affixed onto, or otherwise joined onto existing structures such as wheelchairs, recliners, sofas, beds and portable commode armrests. For instance, the existing structure may have a portion of its frame removed and replaced with the mounting bar, extension tube, and/or grasping handle, or the mounting bar, extension tube, and/or grasping handle may be affixed to the frame of the existing structure. Indeed, existing wheelchairs may be retrofitted to accommodate handles 100 via clamps, inserting handles 100 into existing wheelchair frame tubing, etc. In one embodiment, the frame, arm or hand rail of an existing wheelchair, commode, walker, or other mobility device may be replaced with mounting bar 104, whether in combination with extension tube 106 and grasping handle 108 or not. This could be accomplished by replacing part of the frame, such as the arm or handrail of the herein referenced mobility devices, with the structure of mounting bar 104 or affixing mounting bar 104 to some other part of the mobility devices structure such as the side, undercarriage, back, tube structure, etc. Thus, by fabricating mounting tube 104 into the structure of a wheelchair, walker, or other mobility device, one can achieve the benefits of the current disclosure without completely redesigning the mobility device. This may also be accomplished via adding telescoping adjustments to the mobility device, such as in the case where mounting arm 104 would be affixed to the mobility device at an angle other than parallel to the floor or supporting surface where the mobility device sits. The transfer assist handle can be added, assembled or integrated to an existing wheelchair, commode, furniture or other support device as an aftermarket accessory or it can be integrated in the original design and/or architecture of such. Further, the extension tube and/or mounting bar may be fabricated or integrated into new wheelchair, commode structure, assistive device design of the armrest or specifically placed otherwise as part of or onto the frame, and the transfer handle may be retrofitted the same. The transfer assist pull handle may also be affixed to part of the frame of a wheelchair, commode or other assistive mobility device.

Mounting bar 104, with variable clamp 128 and multiple hole sizes, is designed so as to be easily assembled to any wheelchair, commode, other medical transfer device or fixture and adapt to different available armrests or any base structures of those. Mounting bar 104 is designed in a way that it prevents rotation or undesirable sliding and slipping of the transfer device, once mounted securely and operated correctly.

The most common way to retrofit a wheelchair, commode or other such mobility assistance device would be by removing the cushion on the armrest and using the existing or additional supplied screws and bolts to affix the mounting bar in between or below the armrest rail and cushion. The current models of wheelchairs and commodes allow for the optimum installation methods of mounting bar 104 and extension tube 106 of the current invention for installation using mounting bar 104 to accommodate other wheelchair accessories such grocery buggies, umbrella holders, arm troughs, tray tables, lap tables, cup holders, bag holders, supplemental oxygen tanks, positioning accessories, etc. The accessory will be mounted to mounting bar 104 which has fixed adapter clamp 126 attached to it and will be clamped to the structure. While “clamp” is used any other affixture means known to those of skill in the art such as frictional engagement, male female, mating surface technology, welds, etc., may be used to affix mounting bar 104. The accessory before mentioned may be further secured into place by extension tube 106, which moves freely about mounting bar 104 to assist in carrying the load of the accessory. Extension tube 106 may be further secured to the structure by variable adapter clamp 128, which will couple extension tube 106 to the structure. The accessory will now be secured in place and specifically in regards to a wheelchair or commode the accessory will be secured from sliding forward, backward or laterally.

Caregivers continually search for ways to get their patients to move. Movement improves health in many ways including: 1. Maintaining bone density. Patients lose bone and muscle strength when sitting for an extended time. Transfer handles allow a patient to grab the bar and pull themselves up safely, building muscle capacity and bone density, and decreasing risk of compression fractures as well as many other fractures from falls; 2. Increasing adequate breathing and circulation. Patients who have pulmonary issues, particularly congestion and infections, due to long periods of immobility in a chair. Transfer assist handles allow the patient to stand up using a compound and functional movement, helping circulation in the upper/lower body and decreasing risk of pneumonia. The compound movement of pulling with the upper body along with pushing up with the legs are using the body's greatest strengths from the all-important posterior chain muscle group; 3. Decreasing risk of pressure sores. Patients can develop pressure sores from continuous sitting and immobility. Transfer handles allow the patient to make safe, regular movements out of their seat or reposition themselves to relieve pressure decreasing the risk of sore development; 4. Helps maintain spinal precautions. It is recommended by medical professionals and physical therapists that patients suffering from lumbar and sacral pathologies such as herniated disc, stenosis, compression fractures, back surgeries, as well as many others follow specific physician precautions for no twisting or bending. The transfer assist handles of the current disclosure allow the patient to stand up straight without twisting or bending before standing from their seat. Transfer assist handles will assist the patient in maintaining a neutral spine during these transfers which will decrease risk of another injury or having to revise the surgery which costs the healthcare industry more money.

Handles 100 help mitigate medical issues associated with patient immobility in their chairs. Transfer handles help to improve functional mobility, reduce pain, minimize the potential for muscle and bone damage, decrease the risk for pressure sores, and decrease the chance of pulmonary infections. Thus, handles 100 reduce medical stays and the associated health interventions, which costs health care and care providers billions of dollars per year.

In a further embodiment, see FIG. 10, the current disclosure provides a method 1000 for improving accessibility to and from an existing fixture to assist users in raising themselves from a prone, supine, or sitting position to a standing position without the need for third party help. FIG. 10 shows at step 1002, at least one mounting bar is joined to a first surface of an existing fixture, which may be furniture, medical devices, walls, ceilings, floors, a vehicle, etc., via at least one clamp attached to the at least one mounting bar and the first surface of the existing feature. At step 1004, at least one extension tube is joined to the at least one mounting bar. The extension tube is movably engaged with the mounting bar to move longitudinally and rotationally with respect to the mounting bar. At step 1006, at least one grasping handle is formed on the extension tube. At step 1008, at least one locking mechanism locks the at least one extension tube into a position with respect to the at least one mounting bar. At step 1010, a second mounting bar may be joined to a second surface of the existing fixture. At step 1012, the at least one mounting bar and the second mounting bar may be connected or linked to one another, either functionally, meaning that function of the handles is synchronized with one another, or structurally, such as a physical linkage connecting the arms to one another or a fixture providing support for both adapter arms, such as a platform, an assistive frame, an adjustable securing bar, or via attachment to the frame of a device such as a wheelchair, commode, walker, piece of furniture, bedframe, etc.

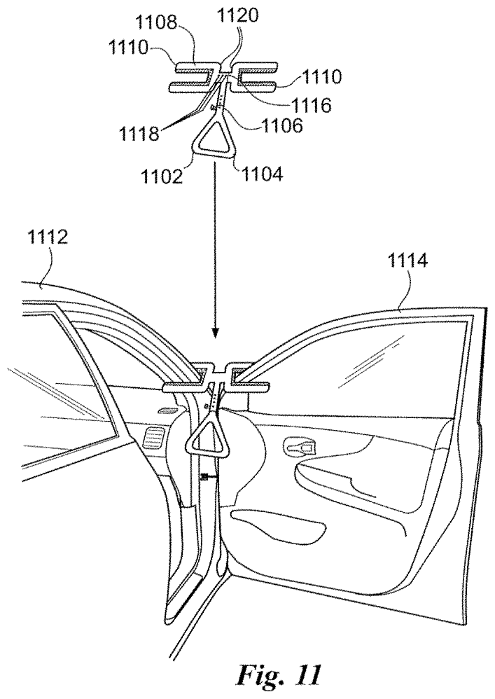

FIG. 11 shows a further embodiment of the current invention wherein handle 100 may be integrated with the interior of a vehicle. FIG. 11 shows a car handle 1102, which may be formed to have a triangular, straight, or other shaped grip 1104. Handle 1102 may be formed with body 1106 to function similar to extension tube 106, including variable adjustment for length and angle as well as locking means as describe supra, and will engage substantially perpendicularly with a car affixment bar 1108. Car affixment bar 1108 may have grasping ends 1110 to “grab” or otherwise engage with a vehicle frame 1112, such as the support for a windshield, and door 1114 of the vehicle. Once engaged, the user may pull on grip 1104 to raise themselves out of the car. Car affixment bar 1108 may allow for adjusting placement of grasping ends 1110 along length 1116 of affixment bar 1108 via a pin and hole engagement as described supra for mounting bar 104 and extension tube 106, such as via placement of affixment bar holes 1118 along the length of affixment bar 1108 to engage pins 1120 associated with grasping ends 1110. This will allow handle 1102 to be used with a variety of car and truck styles. The car transfer assist handle may allow the user a handle to pull themselves into a standing position, pivot, and support the transfer out of the vehicle. The transfer assist handle may be secured by a fixed and variable clamp to the dashboard, roof or other grip safety handles in the vehicle.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A transfer assist pull handle comprising:
at least one mounting bar;
at least one extension tube, wherein the extension tube is movably engaged with the mounting bar to move at least longitudinally and at least rotationally with respect to the mounting bar;
at least one grasping handle formed on the extension tube;
at least one clamp attached to the at least one mounting bar for affixing the transfer pull assist handle to another object; and
at least one locking mechanism that locks the at least one extension tube into position with respect to the at least grasping handle.

2. The transfer assist pull handle of claim 1, further comprising at least one hinge in the at least one grasping handle.

3. The transfer assist pull handle of claim 1, further comprising a furniture adapter sleeve and an mounting bar shell.

4. The transfer assist pull handle of claim 1, further comprising a cushion affixed to the transfer assist pull handle.

5. The transfer assist pull handle of claim 1, further comprising an adjustable securing mechanism and affixer connected to the transfer assist pull handle.

6. The transfer assist pull handle of claim 1, further comprising a locking ring connecting the at least one mounting bar and the at least one extension tube.

7. The transfer assist pull handle of claim 1, further comprising an assistive frame affixed to the transfer assist pull handle.

8. The transfer assist pull handle of claim 1, secured to a second transfer assist pull handle via an adjustable securing bar.

9. The transfer assist pull handle of claim 8, wherein the transfer assist pull handle and the second transfer assist pull handle are affixed to the adjustable securing bar via rotating clamps that provide for rotating the transfer assist pull handle and the second transfer assist pull handle independently of one another with respect to the adjustable securing bar.

10. The transfer assist pull handle of claim 1, wherein the transfer assist pull handle is attached to a wheelchair, commode, or other mobile accessory.

11. The transfer assist pull handle of claim 1, further comprising a joining platform connecting the at least one transfer assist pull handle to a second transfer assist pull handle.

12. The transfer assist pull handle of claim 1, wherein the transfer assist pull handle is attached to a vehicle interior.

13. A method of improving accessibility for an existing fixture via installation of a transfer assist pull handle comprising:
joining at least one mounting bar to a first surface of the existing fixture via at least one clamp attached to the at least one mounting bar and the first surface of the existing fixture;
joining at least one extension tube to the at least one mounting bar, wherein the extension tube is movably engaged with the mounting bar to move longitudinally and rotationally with respect to the mounting bar;
forming at least one grasping handle on the extension tube; and
forming at least one locking mechanism that locks the at least one extension tube into a position with respect to the at least one grasping handle.

14. The method of claim 13, wherein a second mounting bar is joined to a second surface of the existing fixture.

15. The method of claim 13, further comprising forming at least one hinge in the at least one grasping handle.

16. The method of claim 13, further comprising adding a furniture adapter sleeve and a mounting bar shell to the mounting bar.

17. The transfer assist pull handle of claim 13, further comprising forming a joining platform to connect a first transfer assist pull handle to a second transfer assist pull handle.

18. The transfer assist pull handle of claim 13, further comprising connecting the transfer assist handle to an adjustable securing mechanism and affixer.

19. The transfer assist pull handle of claim 13, further comprising connecting the at least one mounting bar and the at least one extension tube via a locking ring.

20. The transfer assist pull handle of claim 13, further comprising connecting the transfer pull handle to an assistive frame.

21. The transfer assist pull handle of claim 13, associating a first transfer pull handle with a second transfer assist pull handle via an adjustable securing bar affixed to the existing structuring wherein the first transfer pull handle and the second transfer pull handle are both affixed to the adjustable securing bar.

22. The transfer assist pull handle of claim 21, wherein the first transfer assist pull handle and the second transfer assist pull handle are affixed to the adjustable securing bar via rotating clamps that provide for rotating the transfer assist pull handle and the second transfer assist pull handle independently of one another with respect to the adjustable securing bar.

23. The transfer assist pull handle of claim 13, wherein the transfer assist pull handle is attached to a wheelchair, commode, or other mobile accessory.

24. The transfer assist pull handle of claim 13, further comprising attaching at least one transfer assist pull handle to a vehicle interior.
